(19) United States
(12) Patent Application Publication
(10) Pub. No.: US 2002/0049067 A1
(43) Pub. Date: Apr. 25, 2002

(54) Communication apparatus

(76) Inventors: Harumichi Tamura, Nara-shi (JP); Tomoko Suezaki, Chiba-shi (JP)

Correspondence Address: BIRCH STEWART KOLASCH & BIRCH, PO BOX 747, FALLS CHURCH, VA, 22040-0747, US

(21) Appl. No.: 09/983,660

(22) Filed: Oct. 25, 2001

(30) Foreign Application Priority Data
Oct. 25, 2000 (JP) P2000-324926

(51) Int. Cl. H04B 7/00

(52) U.S. Cl. 455/517; 455/416

(57) ABSTRACT

An object of the invention is, in a communication apparatus connectable with a mobile (wireless) apparatus, to reduce development costs when a plurality of types of apparatuses are developed. A control circuit confirms the existence of control circuits for cordless use, and checks the number of units mounted in a facsimile apparatus, and as a result, in the case where the number of units mounted in the facsimile apparatus is not plural, the control circuit forbids the processing of a call requiring the plurality of control circuits for cordless use and performs control so that the respective functions do not operate, and in the case where the number of units mounted in the facsimile apparatus is plural, as the need arises, the control circuit executes the processing of a call requiring the plurality of control circuits for cordless use.

### BACKGROUND OF THE INVENTION

1. Field of the Invention

The present invention relates to a communication apparatus connectable with a mobile (wireless) apparatus, and a method of selecting and correcting a function of the communication apparatus.

2. Description of the Related Art

Conventionally there is provided a communication apparatus connectable with a mobile (wireless) apparatus, such as a master telephone unit or facsimile apparatus paired with a cordless slave telephone unit. The communication apparatus such as a master telephone unit or facsimile apparatus is connected to a telephone line, and the cordless telephone unit paired there with is connected by wireless to the master telephone unit or facsimile apparatus to enable an internal telephone call therebetween or communicate with an external telephone unit.

Besides, in the case of some types of such communication apparatuses, a plurality of circuit sections, such as tuners, used for wireless connection to slave telephone units are provided to enable a call between slave telephone units through the communication apparatus such as a master telephone unit or facsimile apparatus, an outside line transfer using a call between slave telephone units, a simultaneous call (conference call using two slave telephone units at the same time) between a plurality of slave telephone units and an outside line, between a plurality of slave telephone units and the master telephone unit, the facsimile apparatus or the like.

However, in a single function type of communication apparatus provided with one circuit section such as a tuner used for wireless connection with a slave telephone unit and a multifunction type of communication apparatus provided with a plurality of circuit sections, normally as different types of communication apparatuses, their control circuits and software are separately designed, so that there is a problem that development costs are required for the respective types of communication apparatuses, and the costs of the respective types of communication apparatuses are increased. Besides, in the case where the single function type of communication apparatus is changed to the multifunction type of communication apparatus because of a change in the family structure of a user, or the like, it has been necessary for the user to buy a new type of communication apparatus.

### SUMMARY OF THE INVENTION

An object of the invention is to provide a communication apparatus in which development costs at the time of development of a plurality of types of communication apparatuses can be reduced, and a changeover from a single function type of communication apparatus to a multifunction type of communication apparatus can be made without buying a new type one, and a method of selecting and correcting a function thereof.

In order to achieve the object, the invention provides a communication apparatus connectable with a mobile wireless apparatus comprises detection means for detecting number of mobile wireless apparatuses which can be simultaneously connected to the communication apparatus, and control means for selecting and correcting a function usable in a body of the communication apparatus based on a detection result of the detection means.

According to the invention, the detection means detects the number of the mobile (wireless) apparatuses which can be simultaneously connected to the communication apparatus, and based on the detection result, the control means selects and corrects the function usable in the communication apparatus body, so that types of apparatuses which are different from each other in number of mobile (wireless) apparatuses which can be simultaneously connected to the communication apparatus can be operated and controlled by a common control circuit and software.

Besides, the invention is constructed such that in addition to the structure, when the number of the mobile (wireless) apparatuses which can be simultaneously connected to the communication apparatus is two or more, the control means sets, as a usable function, a function of using communication between the mobile (wireless) apparatuses through the communication apparatus body.

According to the invention, when the number of the mobile (wireless) apparatuses which can be simultaneously connected to the communication apparatus is two or more, which is detected by the detection means, the control means sets the function of using the communication between the mobile (wireless) apparatuses through the communication apparatus body, so that various functions of using the communication between the mobile (wireless) apparatuses through the communication apparatus body can be suitably set by the common control circuit and software.

Besides, the invention is constructed such that in addition to the structure, a circuit section for connection with a mobile wireless apparatus is made into a unit, and based on number of units of circuit sections mounted in the communication apparatus body, the detection means detects the number of the mobile wireless apparatuses which can be simultaneously connected to the communication apparatus.

According to the invention, based on the number of the units mounted in the communication apparatus body, the detection means detects the number of the mobile (wireless) apparatuses which can be simultaneously connected to the communication apparatus, and based on the detection result, the control means selects and corrects the function usable in the communication apparatus body, so that the function of the communication apparatus can be improved by addition of units.

Further, the invention provides a method of selecting and correcting a function of a communication apparatus connectable with a mobile wireless apparatus, comprising the steps of detecting number of mobile wireless apparatuses which can be simultaneously connected to the communication apparatus and selecting and correcting a function usable in a body of the communication apparatus body based on a detection result.

According to the invention, the number of the mobile (wireless) apparatuses which can be simultaneously connected to the communication apparatus is detected, and the function usable in the communication apparatus body is selected and corrected based on the detection result, so that types of apparatuses which are different from each other in number of mobile (wireless) apparatuses which can be simultaneously connected to the communication apparatus can be operated and controlled by a common control circuit and software.

According to the invention, the number of the mobile (wireless) apparatuses which can be simultaneously connected to the communication apparatus is detected, and the function usable in the communication apparatus body is selected and corrected based on the detection result, so that types of communication apparatuses different in number of mobile (wireless) apparatuses which can be simultaneously connected to the communication apparatus can be operated and controlled by the common control circuit and software, and as a result, it is not necessary to separately design control circuits and software of a single function type of communication apparatus and a multifunction type of communication apparatus, and therefore, the development costs when a plurality of types of communication apparatuses are developed can be reduced.

Besides, according to the invention, the circuit section for connection with the mobile (wireless) apparatus is made into a unit, and the function usable in the communication apparatus body is selected and corrected based on the number of units mounted in the communication apparatus body, so that the function of a type of communication apparatus can be improved by addition of units, and accordingly, the changeover from the single function type of communication apparatus to the multifunction type of communication apparatus can be made without buying a new type of communication apparatus.

### BRIEF DESCRIPTION OF THE DRAWINGS

Other and further objects, features, and advantages of the invention will be more explicit from the following detailed description taken with reference to the drawings wherein:

FIG. 1 is a functional block diagram showing an electrical structure of a facsimile apparatus as an embodiment of a communication apparatus of the invention,

FIG. 2 is a functional block diagram showing an electrical structure of a slave telephone unit connected with the facsimile apparatus by wireless, and

FIG. 3 is a flowchart showing operation control at the time of function selection and correction in the facsimile apparatus.

### DETAILED DESCRIPTION OF THE PREFERRED EMBODIMENTS

Now referring to the drawings, preferred embodiments of the invention are described below.

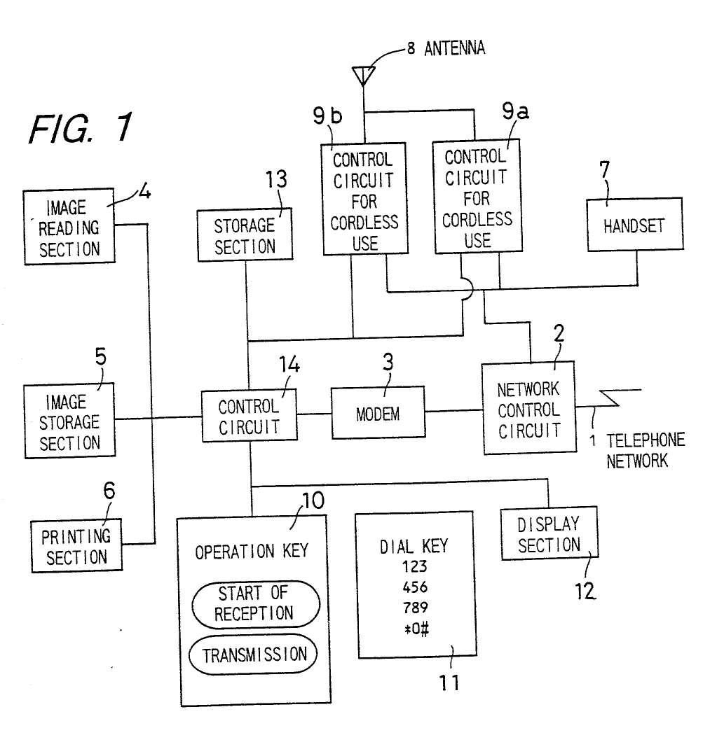

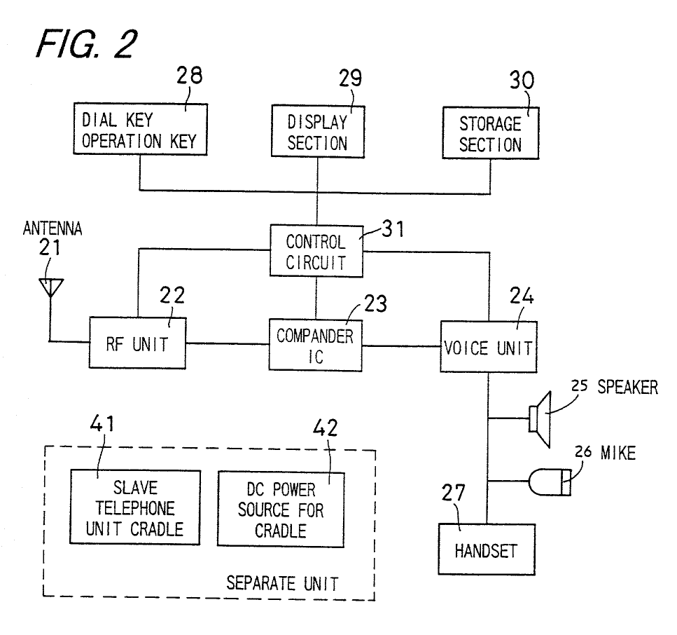

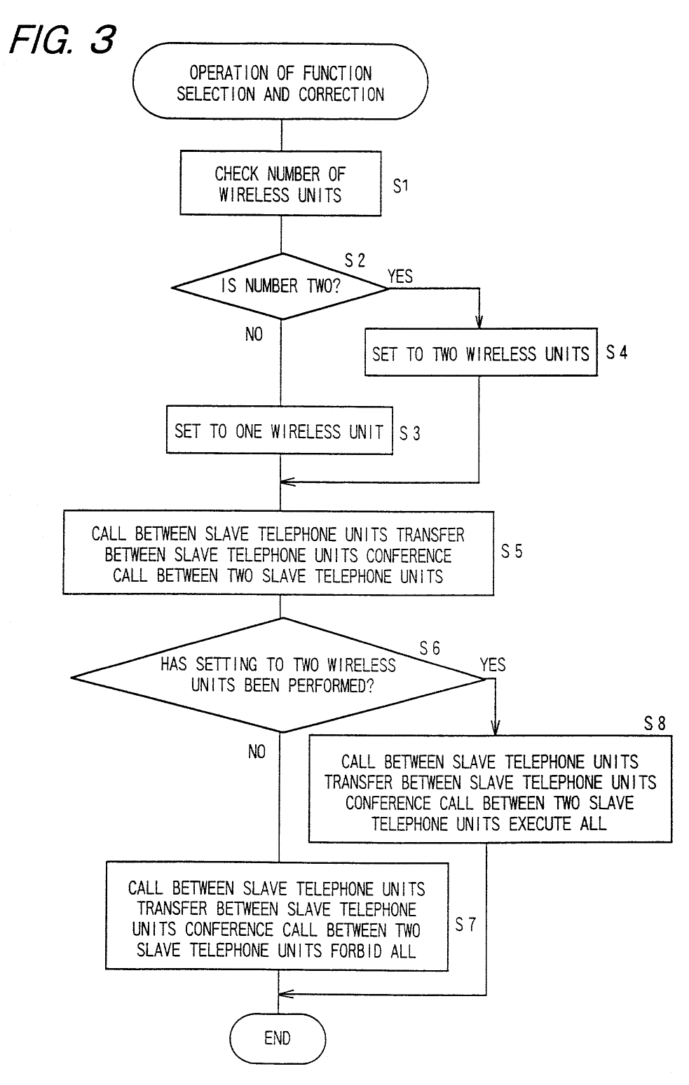

FIG. 1 is a functional block diagram showing an electrical structure of a facsimile apparatus as an embodiment of a communication apparatus of the invention, FIG. 2 is a functional block diagram showing an electrical structure of a slave telephone unit connected with the facsimile apparatus by wireless, and FIG. 3 is a flowchart showing operation control at the time of function selection and correction in the facsimile apparatus.

Hereinafter, a communication system which is called as cordless facsimile apparatus and provided with a facsimile apparatus as an embodiment of a communication apparatus of the invention will be described with reference to FIGS. 1 to 3.

The cordless facsimile apparatus is constituted by a facsimile apparatus and a slave telephone unit.

In FIG. 1, the facsimile apparatus is constituted by a net control circuit 2, a modem 3, an image reading section 4, an image storage section 5, a printing section 6, a handset 7, an antenna 8, control circuits 9a, 9b for cordless use, an operation key 10, a dial key 11, a display section 12, a storage section 13, and a control circuit 14.

The net control circuit 2 monitors the state of a telephone network 1 connected to a not-shown switchboard and changes a connection party of the line. The modem 3 converts a digital signal into an analog signal suitable for the telephone network 1, and converts an analog signal from the telephone network 1 into a digital signal. The image reading section 4 is a apparatus for reading an image from an original and converting it into image data, and is realized by a reduction read system with a combination of a lens and a CCD line sensor, a contact sensor system using a rod lens array or the like.

The image storage section 5 stores the digital signal converted by the modem 3 or the image data read by the image reading section 4. The printing section 6 is a apparatus for printing, as an image, the digital signal converted by the modem 3, the image data read by the image reading section 4, or the image data readout of the image storage section 5, and is realized by a thermal system, an electrophotographic system, an ink jet system or the like.

In the control circuits 9a, 9b for cordless use, a circuit section used for wireless connection with a slave telephone unit is made into a unit. Each of the control circuits 9a, 9b for cordless use includes a control section for performing search of a communication path or establishment of connection, a compander section for compressing and restoring a signal, and a tuner for transmitting or receiving an electric wave. In the control circuits 9a, 9b for cordless use, for example, when a request of a call with a slave telephone unit is received, carrier sense of a channel for control is performed, and a space of the control channel is checked. When communication can be made in the control channel, transmission of an ID signal of a master telephone unit and an ID signal of a slave telephone unit, reception and confirmation of the ID signal from each slave telephone unit, confirmation of the available channel for the call, designation of the call channel, setting of the call path, and the like are performed by using this control channel, the call path to the slave telephone unit is established, and the processing for ending the call is performed when the call is ended. Like this, the control circuits 9a, 9b manage all processings from the establishment of the call with the slave telephone unit to the completion of the call.

Incidentally, when either of the control circuits 9a, 9b for cordless use is mounted, the facsimile apparatus performs the functions as the master telephone unit, that is, the functions such as an outside line call by a slave telephone unit, and an extension call between the facsimile apparatus and the slave telephone unit.

The antenna 8 is connected to the control circuits 9a, 9b for cordless use. The handset 7 is connected to the control circuits 9a, 9b for cordless use and is connected to the net control circuit 2.

The operation key 10 gives instructions to start and stop various functions. The dial key 11 performs an input of a telephone number and the like. The display section 12 displays various states of the facsimile apparatus. The storage section 13 stores a control program for causing various operations of the facsimile apparatus to be executed and various states. The control circuit 14, together with the control program stored in the storage section 13, determines the operation of the whole apparatus on the basis of input information from the operation key 10 or the dial key 11, information indicating states from the respective units 3, 4, 5, 6, 9a, 9b, and 12, and information such as a signal from the telephone network 1, gives instructions to the whole apparatus, and also performs compression of an image signal and expansion to return the compressed image signal to original pixel line information.

In FIG. 2, a slave telephone unit is constituted by an antenna 21, an RF apparatus 22, a compander IC 23, a voice apparatus 24, a speaker 25, a mike 26, a handset 27, a dial key and operation key 28, a display section 29, a storage section 30, and a control circuit 31. Besides, the slave telephone unit is provided with a separate apparatus comprised of a slave telephone unit cradle 41, and a charging DC power source 42 as a cradle power source.

The antenna 21 is connected to the RF apparatus 22. The RF apparatus 22 is mainly constructed by a tuner for transmitting and receiving an electric wave of a voice control signal through the antenna 21. A wireless communication system in the RF apparatus 22 includes several kinds of frequency modulation systems, such as a normal electric power saving cordless telephone system, a minute electric power system, or a PHS common use type.

The compander IC 23 nonlinearly compresses a signal to be transmitted to cause a clear conversation to be made within the range of a frequency band irrespective of the loudness of a voice, and expands and demodulates the received compressed signal. The voice apparatus 24 is provided with a power amplifier and the like. The high output speaker 25, the mike 26, and the handset 27 are connected to the voice apparatus 24, respectively.

The dial key and operation key 28 performs an input of a telephone number, and start and stop instructions of various functions. The display section 29 displays various states of the slave telephone unit. The storage section 30 stores a control program for causing various operations of the slave telephone unit to be executed and various states. The control circuit 31, together with the control program stored in the storage section 30, determines the operation of the whole apparatus on the basis of input information from the dial key and operation key 28, information indicating states from the respective units 23, 24, and 29, and information such as a signal from the RF apparatus 22, gives instructions to the whole apparatus, and performs confirmation of an available channel of control channels and call channels, confirmation of a body ID, confirmation of a slave telephone unit ID, transmission, and the like, and also performs a processing necessary for establishment and cutting of a call path.

Hereinafter, with respect to the cordless facsimile apparatus constructed as described above, the operation at the time of function selection and correction in the facsimile apparatus will be described on the basis of a flowchart shown in FIG. 3.

When electric power is supplied to the facsimile apparatus, the operation of function selection and correction is started, and the control circuit 14 confirms the existence of the control circuits 9a, 9b for cordless use (abbreviated to wireless units in FIG. 3), and checks the number of units mounted in the facsimile apparatus (step S1). As a result, in the case where the number of units mounted in the facsimile apparatus is not plural (normally, two), that the number of wireless units is one is stored and set in the storage section 13 (steps S2, S3), and in the case where the number of units mounted in the facsimile apparatus is plural, that the number of wireless units is two is stored and set in the storage section 13 (steps S2, S4).

Thereafter, when the plurality of control circuits 9a, 9b for cordless use become necessary (step S5), the number of wireless units stored and set in the storage section 13 is confirmed. As a result, in the case where that the number of wireless units is one has been stored and set, the control circuit 14 forbids the processing of a call requiring the plurality of control circuits 9a, 9b for cordless use, and makes control so that the respective functions do not operate (steps S6, S7). In the case where that the number of wireless units is two has been stored and set, the control circuit 14 executes the processing of a call requiring the plurality of control circuits 9a, 9b for cordless use (steps S6, S8).

Incidentally, as the call requiring the plurality of cordless circuits 9a, 9b for cordless use, there are a call between slave telephone units through the facsimile apparatus as a relay, an outside line transfer between slave telephone units (in the case where transfer is once performed from a slave telephone unit to a master telephone unit and is again performed to another slave telephone unit, the processing is enabled by one cordless control circuit, however, in the case where transfer is directly performed from a slave telephone unit to another slave telephone unit, two cordless control circuits are required), a conference call using two slave telephone units at the same time, and the like.

Accordingly, according to the operation control, the number of wireless units mounted in the facsimile apparatus at the time of power supply is confirmed and is stored and set, and thereafter, when a plurality of wireless units are required, according to the stored and set number of wireless units, the processing of the call requiring the plurality of wireless units is forbidden or executed. Therefore, types of apparatuses different from each other in number of mobile (wireless) apparatuses which can be simultaneously connected to the communication apparatus can be operated and controlled by the common control circuit and software, and by merely mounting the control circuit 9b for cordless use in the state where the control circuit 9a for cordless use is mounted in the facsimile apparatus, the single function type of communication apparatus can be handled as the multifunction type of communication apparatus without changing the storage circuit 13 and the control circuit 14.

Thus, as compared with the case where the control circuits of the single function type of communication apparatus and the multifunction type of communication apparatus are separately designed, development efforts for the respective types of apparatuses can be reduced to an effort for one type of communication apparatus, and therefore, the development costs of the respective types of apparatuses can be reduced, and the upgrade of an already sold communication apparatus can be easily performed.

Incidentally, in the operation control, although the number of the wireless units is set to two, even in the case of three or more units, similar control flow can be used. This is because when the number of wireless units is increased, although a complicated call is possible by that, the control is not changed from the case of two units in principle.

Besides, in the operation control, in view of cutting of the power source at the time of additional mounting of a wireless apparatus, when electric power is supplied to the facsimile apparatus, the number of wireless units is checked, and setting and correction of a function is performed. However, the invention is not limited to this, for example, the number of wireless units may be checked each time a call is made, and setting and correction of a function may be performed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication apparatus connectable with a mobile wireless apparatus comprising:
detection means for detecting number of mobile wireless apparatuses which can be simultaneously connected to the communication apparatus; and
control means for selecting and correcting a function usable in a body of the communication apparatus based on a detection result of the detection means.

2. The communication apparatus of claim 1, wherein, when the number of the mobile wireless apparatuses which can be simultaneously connected to the communication apparatus is two or more, the control means sets, as a usable function, a function of using communication between the mobile wireless apparatuses through the communication apparatus body.

3. The communication apparatus of claim 1,
wherein a circuit section for connection with a mobile wireless apparatus is made into a unit, and
based on number of units of circuit sections mounted in the communication apparatus body, the detection means detects the number of the mobile wireless apparatuses which can be simultaneously connected to the communication apparatus.

4. A method of selecting and correcting a function of a communication apparatus connectable with a mobile wireless apparatus, comprising the steps of:
detecting number of mobile wireless apparatuses which can be simultaneously connected to the communication apparatus; and
selecting and correcting a function usable in a body of the communication apparatus body, based on a detection result.
